(19) United States
(12) Patent Application Publication
(10) Pub. No.: US 2025/0124350 A1
(43) Pub. Date: Apr. 17, 2025

(54) METHOD FOR TRAINING DATA ANNOTATION MODEL, DATA ANNOTATION METHOD, AND CORRESPONDING APPARATUSES

(71) Applicant: Beijing Youzhuju Network Technology Co., Ltd., Beijing (CN)

(72) Inventors: Yukun MA, VANCOUVER (CA); Yingtong BU, Beijing (CN)

(21) Appl. No.: 18/883,980

(22) Filed: Sep. 12, 2024

(30) Foreign Application Priority Data
Oct. 11, 2023 (CN) 202311315584.7

(51) Int. Cl. G06N 20/00; G06F 16/2457

(52) U.S. Cl. CPC G06N 20/00; G06F 16/24573

(57) ABSTRACT

A method for training a data annotation model, a data annotation method, and corresponding apparatuses are provided. The method includes: acquiring sample data that satisfies preset annotation conditions, where the preset annotation conditions include individual annotation conditions derived from breakdown of an annotation rule corresponding to an annotation task, and the sample data corresponds to chain-of-thought information, which is used to indicate whether the sample data belongs to an annotation category corresponding to the annotation task, and a corresponding reason; determining a sample question corresponding to the sample data based on the annotation category and the sample data, and determining a sample answer corresponding to the sample data based on the chain-of-thought information; and performing model training based on the sample question and the sample answer to obtain a target data annotation model used to obtain an answer to the question.

### CROSS REFERENCE TO RELATED APPLICATIONS

The present application claims the priority and benefits of the Chinese Patent Application No. 202311315584.7, entitled “A Method for Training a Data Annotation Model, a Data Annotation Method, and Corresponding Apparatuses” filed on Oct. 11, 2023, the entire content of which is incorporated into the present application by reference.

### TECHNICAL FIELD

The present disclosure relates to the technical field of data processing, and specifically, to a method for training a data annotation model, a data annotation method, and corresponding apparatuses.

### BACKGROUND

In the field of data annotation, data is typically manually annotated by human annotators based on specific annotation rules for each annotation task. However, annotators have varying levels of expertise, particularly for specialized tasks that require domain knowledge. This inconsistency in annotator expertise can lead to discrepancies in the assigned categories for the same data by different annotators, and the accuracy rate of the assigned annotation categories cannot be guaranteed. Moreover, the efficiency of manual annotation is low.

### SUMMARY

The Summary of the Invention section is provided to give a brief overview of concepts, which will be described in detail later in the section Detailed Description of Embodiments. The Summary section is neither intended to identify key or necessary features of the technical solutions claimed, nor is it intended to be used to limit the scope of the technical solutions claimed.

According to a first aspect, the present disclosure provides a method for training a data annotation model, the method including:
acquiring sample data that satisfies preset annotation conditions, where the preset annotation conditions include individual annotation conditions derived from breakdown of an annotation rule corresponding to an annotation task, and the sample data corresponds to chain-of-thought information, which is used to indicate whether the sample data belongs to an annotation category corresponding to the annotation task, as well as a corresponding reason;
determining a sample question corresponding to the sample data based on the annotation category and the sample data, and determining a sample answer corresponding to the sample data based on the chain-of-thought information; and
performing model training based on the sample question and the sample answer to obtain a target data annotation model, where the target data annotation model is used to obtain, based on an input question including target data, an answer to the question, and the answer includes category information of the target data and target chain-of-thought information corresponding to the category information.

According to a second aspect, the present disclosure provides a data annotation method, including:
acquiring a question including target data;
inputting the question into a target data annotation model to obtain an answer to the question, the answer including category information of the target data and target chain-of-thought information corresponding to the category information, where the target data annotation model is obtained through model training performed according to any one of the methods for training a data annotation model of the first aspect; and annotating the target data based on the category information.

According to a third aspect, the present disclosure provides an apparatus for training a data annotation model, the apparatus including:
a first acquiring module, configured to acquire sample data that satisfies preset annotation conditions, where the preset annotation conditions include individual annotation conditions derived from breakdown of an annotation rule corresponding to an annotation task, and the sample data corresponds to chain-of-thought information, which is used to indicate whether the sample data belongs to an annotation category corresponding to the annotation task, as well as a corresponding reason;
a first determination module, configured to determine a sample question corresponding to the sample data based on the annotation category and the sample data, and determine a sample answer corresponding to the sample data based on the chain-of-thought information; and
a training module, configured to perform model training based on the sample question and the sample answer to obtain a target data annotation model, where the target data annotation model is used to obtain, based on an input question including target data, an answer to the question, and the answer includes category information of the target data and target chain-of-thought information corresponding to the category information.

According to a fourth aspect, the present disclosure provides a data annotation apparatus, including:
a second acquiring module, configured to acquire a question including target data;
an input module, configured to input the question into a target data annotation model to obtain an answer to the question, the answer including category information of the target data and target chain-of-thought information corresponding to the category information, where the target data annotation model is obtained through model training performed by the apparatus for training a data annotation model of the third aspect; and
an annotation module, configured to annotate the target data based on the category information.

According to a fifth aspect, the present disclosure provides a computer-readable medium having a computer program stored thereon, where the program, when executed by a processing apparatus, causes the steps of any one of the methods of the first aspect or the second aspect to be implemented.

According to a sixth aspect, the present disclosure provides an electronic device, including:
a storage apparatus having a computer program stored thereon; and
a processing apparatus, configured to execute the computer program in the storage apparatus to implement the steps of any one of the methods of the first aspect or the second aspect.

Through the above technical solution, an annotation rule corresponding to the annotation task is broken down into individual annotation conditions, making it easier for the model to understand and learn the annotation procedure, thus improving the efficiency of model training. Future data annotation through the trained data annotation model will not be affected by levels of expertise of annotators, preventing inconsistency in the annotation category of the same data. Therefore, this approach can achieve higher accuracy and efficiency compared to manual annotation. In addition, the target chain-of-thought information corresponding to the category information allows users to clearly understand the reasoning behind the determined category information.

The other features and advantages of the present disclosure will be described in detail in the following section Detailed Description of Embodiments.

### BRIEF DESCRIPTION OF DRAWINGS

The foregoing and other features, advantages, and aspects of embodiments of the present disclosure will become more apparent from the following description of the specific implementations with reference to the accompanying drawings. Throughout the accompanying drawings, the same or similar reference numerals denote the same or similar elements. It should be understood that the accompanying drawings are schematic and that parts and elements are not necessarily drawn to scale. In the accompanying drawings:

FIG. 1 is a flowchart of manual annotation according to an exemplary embodiment;

FIG. 2 is a schematic flowchart of a method for training a data annotation model according to an exemplary embodiment;

FIG. 3 is a schematic diagram of breaking down an annotation task according to an exemplary embodiment;

FIG. 4 is a schematic diagram of sample data according to an exemplary embodiment;

FIG. 5 is a schematic diagram of sample data according to an exemplary embodiment;

FIG. 6 is a schematic diagram of sample data according to an exemplary embodiment;

FIG. 7 is a flowchart of training a data annotation model according to an exemplary embodiment;

FIG. 8 is a schematic flowchart of a data annotation method according to an exemplary embodiment;

FIG. 9 is a block diagram of an apparatus for training a data annotation model according to an exemplary embodiment;

FIG. 10 is a block diagram of a data annotation apparatus according to an exemplary embodiment; and

FIG. 11 is a block diagram of an electronic device according to an exemplary embodiment.

### DETAILED DESCRIPTION

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Further, additional steps may be included and/or the execution of the illustrated steps may be omitted in the method implementations. The scope of the present disclosure is not limited in this aspect.

The term “comprise/include” used herein and variations thereof are an open-ended inclusion, namely, “comprising/including but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of other terms will be given in the description below.

It should be noted that concepts such as “first” and “second” mentioned in the present disclosure are only used to distinguish different apparatuses, modules, or units, and are not used to limit the order or relation of interdependence of functions performed by these apparatuses, modules, or units.

It should be noted that the modifiers “one” and “a plurality of” mentioned in the present disclosure are illustrative and not restrictive, and those skilled in the art should understand that unless otherwise explicitly specified in the context, the modifiers should be understood as “one or more”.

The names of messages or information exchanged between a plurality of apparatuses in the implementations of the present disclosure are used for illustrative purposes only, and are not used to limit the scope of these messages or information.

The artificial intelligence generated content (AIGC) technology can complete various data tasks such as automatic annotation, automatic writing, and machine translation by automatically generating content of natural languages, images, videos, and audios. In the field of data annotation, data is typically manually annotated by people based on an annotation rule in an annotation task, such as a standard operation procedure (SOP). Alternatively, the data is preliminarily screened through a model, followed by manual review and annotation, which means that manual intervention by a human annotator is required.

As annotators have varying levels of expertise, particularly for specialized tasks that require domain knowledge, the annotators may be divided into professional knowledge-based annotators and common knowledge-based annotators based on whether annotation requires professional domain knowledge. The professional knowledge-based annotators typically need to grasp knowledge in specific domains to complete specific annotation tasks. For example, an annotator in an advertising system needs to grasp knowledge related to advertising laws, advertising placement rules, etc., which requires extensive training upfront. Moreover, once certain rules change, retraining for the annotator is needed. The training cycle for these professional knowledge-based annotators is long, making it difficult to rapidly adapt to changes and process tasks in a timely manner. The common knowledge-based annotators typically do not need to grasp the knowledge in the specific fields, and can complete annotation tasks only by annotating data based on steps and rules defined by the SOP. The training cycle for these common knowledge-based annotators is shorter, they can onboard quickly, and the entry barrier is relatively low.

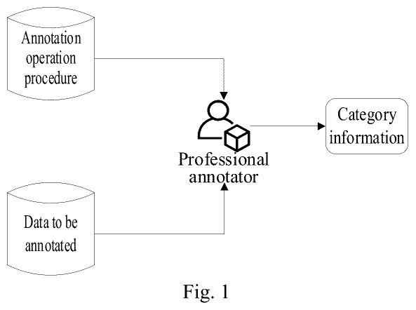

Generally speaking, data annotation tasks may be completed by the above two types of annotators. As shown in FIG. 1, the professional knowledge-based annotator learns an annotation operation procedure for an annotation task through grasped knowledge in the professional domains, then annotates data to be annotated, and finally outputs information about a category that the data belongs to, or other information. However, even for the professional knowledge-based annotators, there are still some issues that can arise when they are annotating data.

For example, if a single data item is annotated by three annotators, it is possible that the three annotators may annotate different annotation categories, making it difficult to identify the true category of the data. This situation often occurs in scenarios of complex tasks, complex rules, or involving a wide range of knowledge domains, which means a low consistency rate in the manual annotation.

For another example, each annotator subjectively understands the SOP differently. Therefore, regardless of how well-aligned a training process is, there are always deviations that cannot be avoided, especially for complex rules, where the deviations are greater. As a result, it is difficult to ensure an accuracy rate of the manual annotation. For example, out of 100 pieces of data, the annotators may only correctly annotate 80, resulting in a relatively low accuracy rate.

Moreover, it is apparent that the manual annotation is low in efficiency compared to automatic annotation using models. As the volume of annotations and the number of annotators increase, an annotation difference rate also rises. In addition, the manual annotation has significant limitations when it comes to languages. For example, there is a shortage of annotators for minority languages, making it difficult to perform the manual annotation on data of the minority languages.

In view of this, the present disclosure provides a method for a training a data annotation model, a data annotation method, and corresponding apparatuses to solve the above technical problems.

Embodiments of the present disclosure are further explained and described in combination with the accompanying drawings as below.

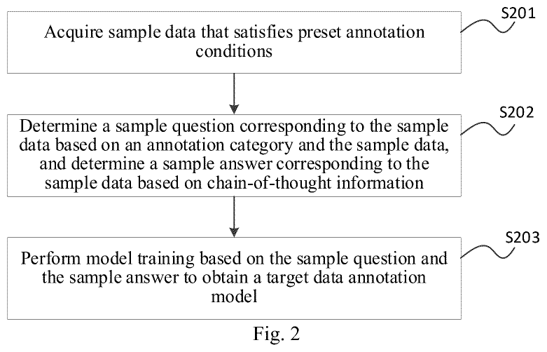

FIG. 2 is a flowchart of a method for training a data annotation model according to an exemplary embodiment of the present disclosure. Referring to FIG. 2, the method may include the following steps.

At S201, sample data that satisfies preset annotation conditions is acquired.

The preset annotation conditions include individual annotation conditions derived from breakdown of an annotation rule corresponding to an annotation task. The sample data corresponds to chain-of-thought information, which is used to indicate whether the sample data belongs to an annotation category corresponding to the annotation task, as well as a corresponding reason.

At S202, a sample question corresponding to the sample data is determined based on the annotation category and the sample data, and a sample answer corresponding to the sample data is determined based on the chain-of-thought information.

At S203, model training is performed based on the sample question and the sample answer to obtain a target data annotation model.

The target data annotation model is used to obtain, based on an input question including target data, an answer to the question. The answer includes category information of the target data and target chain-of-thought information corresponding to the category information.

With the above method, an annotation rule corresponding to the annotation task is broken down into individual annotation conditions, making it easier for the model to understand and learn the annotation procedure, thus improving the efficiency of model training. Future data annotation through the trained data annotation model will not be affected by the levels of expertise of the annotators, preventing inconsistency in the annotation category of the same data. Therefore, this approach can achieve higher accuracy and efficiency compared to manual annotation. In addition, the target chain-of-thought information corresponding to the category information allows users to clearly understand the reasoning behind the determined category information.

In a possible implementation, acquiring sample data that satisfies preset annotation conditions may include: acquiring the sample data according to at least one of the following approaches: acquiring first sample data that satisfies each individual annotation condition and does not satisfy an exemption condition; acquiring second sample data that satisfies a plurality of the individual annotation conditions simultaneously and does not satisfy the exemption condition; and acquiring third sample data that satisfies at least one individual annotation condition and satisfies the exemption condition, where the exemption condition represents a condition under which the sample data is not to be annotated with the annotation category.

It should be understood that typically, the annotation tasks have standard operation procedure (SOP) documents, and annotator training and annotations are based on these SOP documents. In this process, the annotators need to remember a large number of unfamiliar concepts for different rules, which often imposes a significant burden on the annotators. Therefore, for specific rules and categories, the rules or categories may be split until the resulting rules or categories can be understood based on common knowledge. The splitting process may be continuously optimized according to demands.

For example, with respect to the resulting rules after splitting, there may be the following three cases:
1. the data to be annotated conforms to a certain rule;
2. the data to be annotated conforms to a plurality of rules simultaneously; and
3. the data to be annotated conforms to one or more rules, but falls under an exception or exemption.

Further, corresponding sample data may be acquired for at least one of the above three cases to cover possible cases in an actual business scenario, thereby improving the accuracy rate of the data annotation model.

In a possible implementation, the individual annotation conditions are obtained by: acquiring a standard operation procedure document corresponding to an annotation task; and breaking down an annotation rule for an annotation category in the standard operation procedure document to obtain individual annotation conditions corresponding to an associated category of the annotation category; or, breaking down the annotation rule for the annotation category in the standard operation procedure document to obtain individual annotation conditions corresponding to a subcategory of the annotation category, and determining individual annotation conditions corresponding to an associated category of the subcategory.

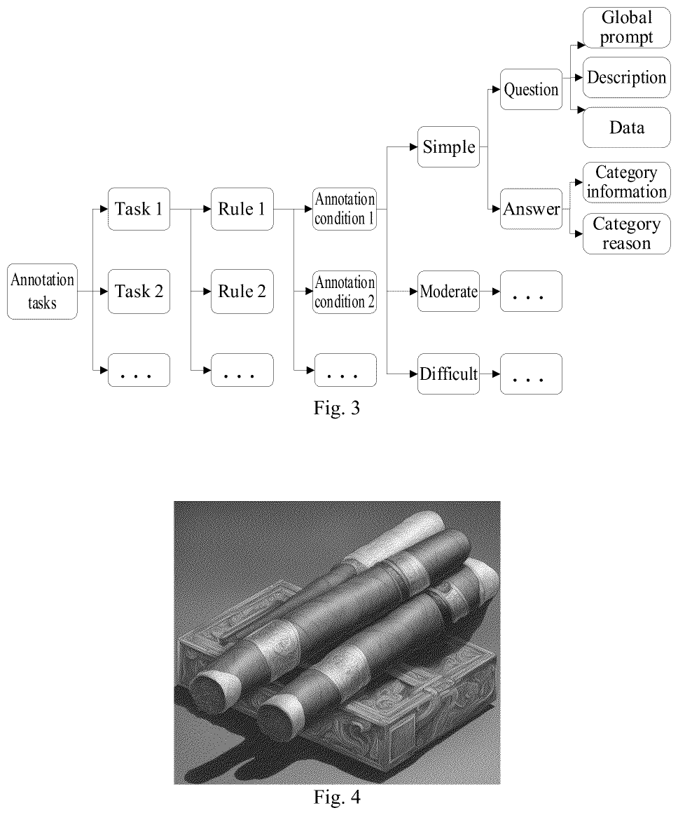

For example, referring to FIG. 3, all annotation tasks may be split into different annotation categories or rules. Each rule (Category) may be broken down into common knowledge-based annotation conditions or provisions. Additionally, the difficulty level of the annotation conditions may be categorized based on the three cases mentioned above. For example, satisfying an individual annotation condition is considered as a simple annotation condition, satisfying a plurality of individual annotation conditions simultaneously is considered as a moderate annotation condition, satisfying at least one individual annotation condition and also an exemption rule is a difficult annotation condition, and so on. The present disclosure does not impose limitations on this.

It should be noted that by transforming the SOP of each annotation task into common knowledge and breaking down the complex SOP into annotation conditions that are easier for the model to learn and understand, helping the model to learn the annotation procedure. For example, a certain annotation task that requires annotating whether a picture belongs to a smoking or cigarette category, and the content of the SOP is as below: if the image exhibits visual features related to encouraging or inducing smoking, or any cigarette-related visual features, the image may be annotated with the category; and if the context of the image indicates a flavoring product, the image does not belong to the category. In the above SOP content, if manual annotation is to be performed by the annotator, the annotator would need to spend a considerable amount of time learning and grasping relevant knowledge since specific information about a cigarette product and a category, as well as specific information of the flavoring product are not provided.

For example, the above SOP content may be broken down into common knowledge-based content. For example:
1. If an image shows any of the following content, the image may be annotated with the category: a cigarette, a cigar, chewing tobacco, a pipe, a hookah, a hookah lounge, rolling paper, a vapor delivery apparatus, and an e-cigarette.
2. If an image shows tobacco-related text content, the image can be annotated with the category.
3. If an image shows a smoking-related behavior, the image can be annotated with the category.
4. If an image shows a text or symbol related to smoking prohibition or opposition, the image is not to be annotated with the category.
5. If the context of an image indicates a flavoring product and also has tobacco-related references, the image is not to be annotated with the category.
6. If an image is a screenshot or footage from a movie, a television program, a video game, or other media, even if smoking-related visual features appear, the image is not to be annotated with the category.

In other words, the annotation category may be broken down into the associated categories of the annotation category. For example, the smoking-related behavior, the tobacco-related text content, etc. belong to the associated categories of the smoking or cigarette category, thereby determining the individual annotation conditions corresponding to the associated categories. The annotation category may also be broken down into subcategories corresponding to the annotation category. For example, the cigarette, the cigar, the chewing tobacco, the pipe, the hookah, and the e-cigarette are all subcategories under the smoking or cigarette category, thereby obtaining the individual annotation conditions for each subcategory. The individual annotation conditions corresponding to the associated categories of the subcategories may also be determined. For example, the hookah lounge is an associated category corresponding to the hookah, and so on. Specifically, the breakdown may be performed based on actual cases, which is not limited by the present disclosure.

In a possible implementation, the exemption condition includes at least one of the following conditions: the sample data includes content representing that the sample data does not belong to the annotation category; the sample data includes content of other categories in addition to the annotation category; and a data source of the sample data satisfies preset conditions.

For example, continuing to refer to the above breakdown of the SOP content into the common knowledge-based content, the exemption rule in the SOP may also be broken down to obtain the exemption condition. The sample data includes the content that represents the sample data does not belong to the annotation category, such as a fruit-related picture, which does not belong to the smoking or cigarette category. The sample data includes the content of the other categories in addition to the annotation category, such as the text and the symbol related to smoking prohibition, and the flavoring product including the tobacco. The data source of the sample data satisfies the preset conditions, such as the screenshot or the footage from the movie, the television program, the video game, or the other media. Specific content may be determined according to demands, which is not limited by the present disclosure.

It should be found that by breaking down the SOP, the annotation task requiring the professional knowledge is transformed into a common knowledge-based annotation task, which converts an abstract definition into a specific rule, thereby simplifying model construction and greatly improving model performance. Moreover, after converting a professional definition into a common knowledge-based rule, even non-professional annotators or models with common knowledge may also complete the annotation task. Therefore, professional annotators only need to break down the SOP into the common knowledge without the need for a large number of professional annotators to perform manual annotation, thereby improving annotation efficiency.

In a possible implementation, acquiring sample data that satisfies preset annotation conditions may include: generating sample data based on the preset annotation conditions and a data generation model; and/or searching for sample data in a sample database based on the preset annotation conditions.

For example, the sample data may be generated based on the preset annotation conditions and the data generation model. The data generation model may be a text-to-text model, a text-to-image model, etc., which is specifically selected according to demands. For example, a text-to-image model is selected to generate sample data in a picture form. The present disclosure does not impose limitations on this. A search engine and the sample database may also be searched for the sample data based on the preset annotation conditions. The present disclosure does not impose limitations on this.

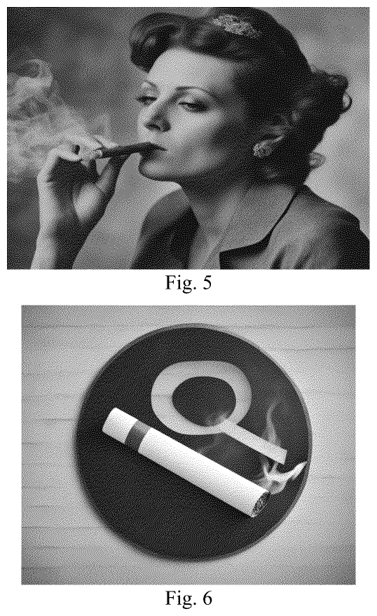

For example, acquiring sample data corresponding to the above three cases is used as an example for illustration. Sample data that satisfies an individual annotation condition is acquired, such as an image that only includes visual features of a cigar, as shown in FIG. 4. Sample data that satisfies a plurality of the individual annotation conditions simultaneously is acquired, such as an image that includes a cigar and shows a smoking behavior, as shown in FIG. 5. Sample data that satisfies at least one individual annotation condition and an exemption rule is acquired, such as an image that includes a cigar but belongs to a smoking prohibition sign, as shown in FIG. 6. A certain amount of data may be acquired according to demands. For example, 100 images are acquired for each case. The present disclosure does not impose limitations on this. Images that do not satisfy the preset annotation conditions may also be acquired, thereby covering the possible cases in the actual business scenario and improving the accuracy rate of the data annotation model.

In a possible implementation, the chain-of-thought information corresponding to the sample data is determined through at least one of the following approaches: acquiring manually configured chain-of-thought information for the sample data; when the preset annotation conditions include a plurality of different types of annotation conditions, determining a target annotation condition that the sample data satisfies from the preset annotation conditions, and determining, based on the target annotation condition and a preset chain-of-thought template, the chain-of-thought information corresponding to the sample data; and obtaining initial chain-of-thought information corresponding to the sample data through a model for constructing chain-of-thought information, acquiring a manual verification result for the initial chain-of-thought information, and determining, based on the manual verification result and the initial chain-of-thought information, the chain-of-thought information corresponding to the sample data.

For example, a specific chain of thought (CoT) is constructed for sample data corresponding to each preset annotation condition, thereby helping the model to better learn the annotation procedure. Continuing with the example from the sample data corresponding to the above three cases, for example, a chain of thought constructed for a picture in the case 1 may be “Yes. Because the image includes a cigar, which has a tendency to induce smoking, the image belongs to the smoking/cigarette category.” A chain of thought constructed for a picture in the case 2 may be “Yes. Because the image includes a cigar and shows a smoking behavior, which has a tendency to induce smoking, the image belongs to the smoking/cigarette category.” A chain of thought constructed for a picture in the case 3 may be “No. The image includes a cigar, but the image aims to identify smoking prohibition, and therefore the image does not belong to the smoking/cigarette category.”

For example, automatic generation may be achieved based on the preset annotation conditions and the preset chain-of-thought template. For example, the preset chain-of-thought template may be “Yes. Because the image includes XX, which has a tendency to induce smoking, the image belongs to the smoking/cigarette category.” For the image that includes the cigar and is obtained in the case 1, fill “Cigar” into “XX” in the template, thereby obtaining chain-of-thought information. Further, the above chain-of-thought information may also be manually configured. Alternatively, a model for constructing chain-of-thought information may be constructed for generating the chain-of-thought information, final chain-of-thought information is determined through manual review, and so on. The present disclosure does not impose limitations on this. Therefore, the chain-of-thought information for the sample data can be obtained, which facilitates subsequent model output, helping users to understand the reasoning behind the determined category information.

Further, after the chain-of-thought information for the sample data is determined, a question-answer pair (QA pair) for the sample data may be constructed.

For example, as shown in FIG. 3, for a picture annotation task, a global prompt may be “Analyze the following picture”. A description section provides a description of a question, such as “Determine whether the image belongs to the smoking/cigarette category”. Finally, the sample data is added, thereby obtaining a sample question for the sample image, such as “Analyze the following picture to determine whether the image belongs to the smoking/cigarette category, shown in FIG. 5”.

Then, the chain-of-thought information corresponding to the sample data is used as a sample answer, including category information of the sample data and chain-of-thought information corresponding to the category information, thereby constructing a question-answer pair (QA pair) shown in FIG. 3.

In a possible implementation, the target data annotation model includes at least one of: a text-to-text model, a text-to-image model, an image-to-text model, an image-text multimodal model, and a video-text multimodal model.

For example, the target data annotation model may be an AIGC model, such as a text-to-text model, a text-to-image model, an image-to-text model, an image-text multimodal model, and a video-text multimodal model. The present disclosure does not impose limitations on this.

For example, an initial model may be trained based on the above constructed QA pair, such that the model learns to analyze features in the image to perform category determination and output a determination reason (chain of thought). Model training may include steps such as continue-pretrain, vision-text alignment, supervised fine-tuning, and reinforce learning from human feedback. Necessary steps may be selected according to task requirements. The present disclosure does not impose limitations on this.

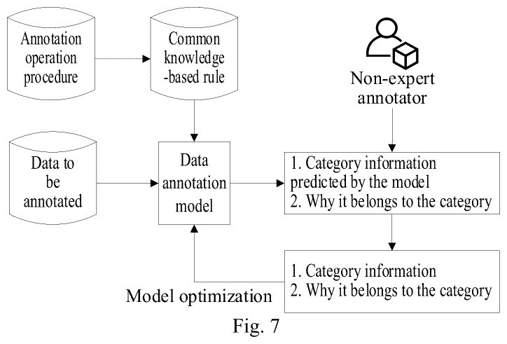

It should be noted that the initial model has possessed a significant amount of common knowledge in a pre-training process, but is not familiar with the knowledge in the professional domains. Therefore, using abstract knowledge in the professional domains and related annotation data directly cannot train a model that achieves or surpasses the level of the manual annotation. Referring to FIG. 7, knowledge in profession domains in an annotation task may be broken down into common knowledge, making it easier for the AIGC model to learn and understand, thereby improving model performance. Then, corresponding sample data is constructed for a common knowledge-based rule, which may reduce dependence on manual annotation of data, and then an initial model is trained to obtain a target data annotation model.

Therefore, in an annotation system that requires long-term participation of the professional annotators, the AIGC model may perform the annotation task, which can not only output category information but also output a reason for determining the category information, allowing non-expert annotators to understand why the data belongs to the category, so as to correct the annotation category for better model optimization. Accordingly, the accuracy rate of annotation of the AIGC model reaches or exceeds the accuracy rate of the manual annotation, and a consistency rate of the annotation of the AIGC model is higher than that of the manual annotation, thereby avoiding deviations, etc.

By adopting the above technical solution to transform an annotation task in the professional domains into a common knowledge-based annotation task that can be rapidly understood by the non-expert annotators, an efficient and high-performance AIGC model can be constructed to complete data annotation tasks in professional domains. Therefore, the annotation task can be completed based on the common knowledge, and even for the data in the minority languages, the annotation task can be performed based on the model, thereby improving the accuracy rate and efficiency of the annotation.

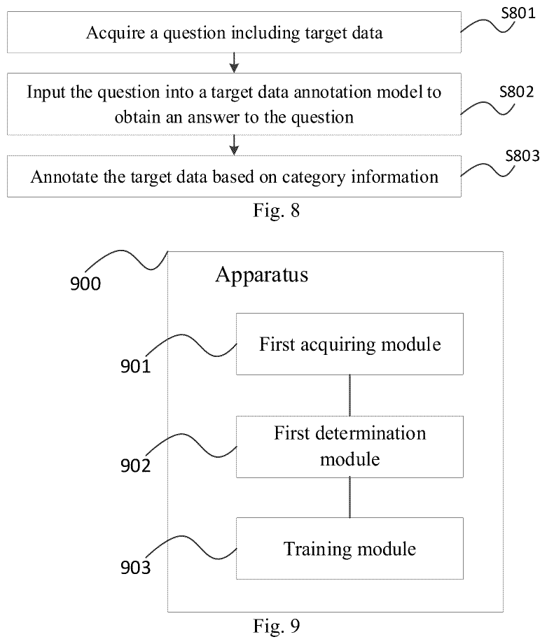

Based on the same inventive concept, the present disclosure provides a data annotation method. Referring to FIG. 8, the method includes the following steps.

At S801, a question including target data is acquired.

At S802, the question is input into a target data annotation model to obtain an answer to the question, where the answer includes category information of the target data and target chain-of-thought information corresponding to the category information.

Here, the target data annotation model is obtained through model training based on the above method for training a data annotation model.

At S803, the target data is annotated based on the category information.

With the above method, data annotation through the trained data annotation model is not affected by the levels of expertise of the annotators, preventing inconsistency in the annotation category of the same data. Therefore, this approach can achieve higher accuracy and efficiency compared to manual annotation. In addition, the target chain-of-thought information corresponding to the category information allows users to clearly understand the reasoning behind the determined category information.

Based on the same inventive concept, the present disclosure provides an apparatus for training a data annotation model. Referring to FIG. 9, the apparatus 900 includes:
a first acquiring module 901, configured to acquire sample data that satisfies preset annotation conditions, where the preset annotation conditions include individual annotation conditions derived from breakdown of an annotation rule corresponding to an annotation task, and the sample data corresponds to chain-of-thought information, which is used to indicate whether the sample data belongs to an annotation category corresponding to the annotation task, as well as a corresponding reason;
a first determination module 902, configured to determine a sample question corresponding to the sample data based on the annotation category and the sample data, and determine a sample answer corresponding to the sample data based on the chain-of-thought information; and
a training module 903, configured to perform model training based on the sample question and the sample answer to obtain a target data annotation model, where the target data annotation model is used to obtain, based on an input question including target data, an answer to the question, and the answer includes category information of the target data and target chain-of-thought information corresponding to the category information.

Optionally, the first acquiring module 901 is configured to:
acquire the sample data according to at least one of the following approaches:
acquiring first sample data that satisfies each of the individual annotation conditions and does not satisfy an exemption condition;
acquiring second sample data that satisfies a plurality of the individual annotation conditions simultaneously and does not satisfy the exemption condition; and
acquiring third sample data that satisfies at least one individual annotation condition and satisfies the exemption condition, where the exemption condition represents a condition under which the sample data is not to be annotated with the annotation category.

Optionally, the exemption condition includes at least one of the following conditions:
the sample data includes content representing that the sample data does not belong to the annotation category;
the sample data includes content of other categories in addition to the annotation category; and
a data source of the sample data satisfies preset conditions.

Optionally, the first acquiring module 901 is configured to:
generate the sample data based on the preset annotation conditions and a data generation model; and/or
search a sample database for the sample data based on the preset annotation conditions.

Optionally, the individual annotation conditions are obtained by:
acquiring a standard operation procedure document corresponding to the annotation task; and
breaking down an annotation rule for the annotation category in the standard operation procedure document to obtain individual annotation conditions corresponding to an associated category of the annotation category; or
breaking down an annotation rule for the annotation category in the standard operation procedure document to obtain individual annotation conditions corresponding to a subcategory of the annotation category, and determining individual annotation conditions corresponding to an associated category of the subcategory.

Optionally, the chain-of-thought information corresponding to the sample data is determined through at least one of the following approaches:
acquiring manually configured chain-of-thought information for the sample data;
when the preset annotation conditions include a plurality of different types of annotation conditions, determining a target annotation condition that the sample data satisfies from the preset annotation conditions, and determining, based on the target annotation condition and a preset chain-of-thought template, the chain-of-thought information corresponding to the sample data; and
obtaining initial chain-of-thought information corresponding to the sample data through a model for constructing chain-of-thought information, acquiring a manual verification result for the initial chain-of-thought information, and determining, based on the manual verification result and the initial chain-of-thought information, the chain-of-thought information corresponding to the sample data.

Optionally, the target data annotation model includes at least one of: a text-to-text model, a text-to-image model, an image-to-text model, an image-text multimodal model, and a video-text multimodal model.

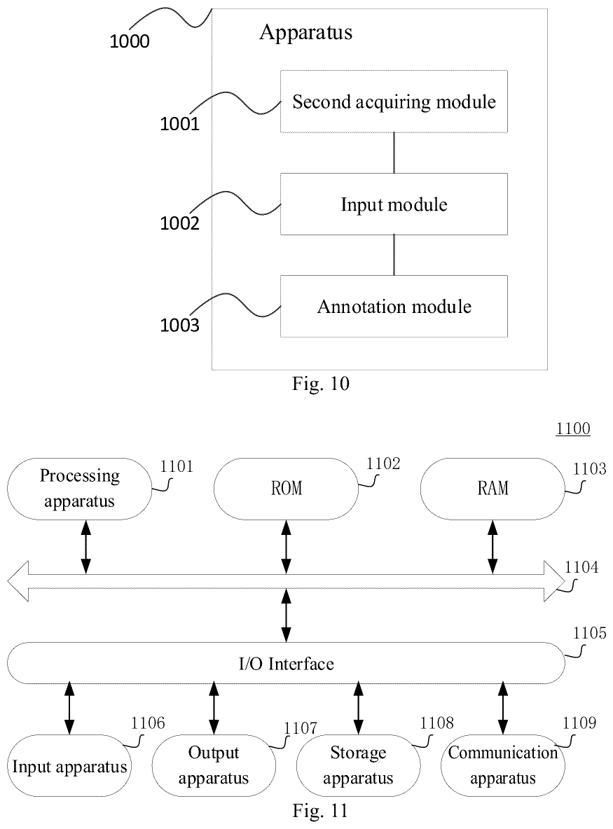

Based on the same inventive concept, the present disclosure provides a data annotation apparatus. Referring to FIG. 10, the apparatus 1000 includes:
a second acquiring module 1001, configured to acquire a question including target data; an input module 1002, configured to input the question into a target data annotation model to obtain an answer to the question, the answer including category information of the target data and target chain-of-thought information corresponding to the category information, where the target data annotation model is obtained through model training performed by the above apparatus for training the data annotation model; and
an annotation module 1003, configured to annotate the target data based on the category information.

With respect to the apparatuses in the above embodiments, the specific manner in which each module performs its operation has been described in detail in the embodiments related to the method, and will not be detailed herein.

Based on the same concept, an embodiment of the present disclosure further provides a computer-readable medium having a computer program stored thereon, where the program, when executed by a processing apparatus, causes the steps of the above method for training a data annotation model or the above data annotation method to be implemented.

Based on the same concept, an embodiment of the present disclosure further provides an electronic device, including:
a storage apparatus having a computer program stored thereon; and
a processing apparatus, configured to execute the computer program in the storage apparatus to implement the steps of the above method for training a data annotation model or the above data annotation method.

Reference is made to FIG. 11 below, which is a schematic diagram of a structure of an electronic device 1100 suitable for implementing an embodiment of the present disclosure. A terminal device in this embodiment of the present disclosure may include, but is not limited to, mobile terminals such as a mobile phone, a notebook computer, a digital broadcast receiver, a personal digital assistant (PDA), a tablet computer (PAD), a portable media player (PMP), and a vehicle-mounted terminal (e.g., a vehicle navigation terminal), and fixed terminals such as a digital TV and a desktop computer. The electronic device shown in FIG. 11 is merely an example, and shall not impose any limitation on the function and scope of use of the embodiments of the present disclosure.

As shown in FIG. 11, the electronic device 1100 may include a processing apparatus (e.g., a central processing unit and a graphics processing unit) 1101 that may perform various suitable actions and processes in accordance with a program stored in a read-only memory (ROM) 1102 or a program loaded from a storage apparatus 1108 into a random access memory (RAM) 1103. The RAM 1103 further stores various programs and data required for the operation of the electronic device 1100. The processing apparatus 1101, the ROM 1102, and the RAM 1103 are connected to one another through a bus 1104. An input/output (I/O) interface 1105 is also connected to the bus 1104.

Generally, the following apparatuses may be connected to the I/O interface 1105: an input apparatus 1106 including, for example, a touch screen, a touchpad, a keyboard, a mouse, a camera, a microphone, an accelerometer, and a gyroscope; an output apparatus 1107 including, for example, a liquid crystal display (LCD), a speaker, and a vibrator; the storage apparatus 1108 including, for example, a tape and a hard disk; and a communication apparatus 1109. The communication apparatus 1109 may allow the electronic device 1100 to perform wireless or wired communication with other devices to exchange data. Although FIG. 11 shows the electronic device 1100 with various apparatuses, it should be understood that it is not necessary to implement or have all the shown apparatuses. It may be an alternative to implement or have more or fewer apparatuses.

In particular, according to an embodiment of the present disclosure, the process described above with reference to the flowcharts may be implemented as a computer software program. For example, an embodiment of the present disclosure includes a computer program product, which includes a computer program carried on a non-transitory computer-readable medium, where the computer program includes program code for performing the method shown in the flowchart. In such embodiment, the computer program may be downloaded and installed from the network through the communication apparatus 1109, or installed from the storage apparatus 1108, or installed from the ROM 1102. The computer program, when executed by the processing apparatus 1101, performs the above functions defined in the method in the embodiments of the present disclosure.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to an electrical connection having one or more wires, a portable computer magnetic disk, a hard disk, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. However, in the present disclosure, the computer-readable signal medium may include a data signal propagated in a baseband or as a part of a carrier, where the data signal carries computer-readable program code. The propagated data signal may take various forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with the instruction execution system, apparatus, or device. The program code included in the computer-readable medium may be transmitted by any suitable medium, including but not limited to: an electric wire, an optical cable, radio frequency (RF), etc., or any suitable combination thereof.

In some implementations, communication may be performed using any currently known or future-developed network protocol such as a hypertext transfer protocol (HTTP), and interconnection with digital data communication (e.g., a communication network) in any form or medium may be achieved. Examples of the communication network include a local area network (“LAN”), a wide area network (“WAN”), an internetwork (e.g., the Internet), a peer-to-peer network (e.g., an ad hoc peer-to-peer network), and any currently known or future-developed network.

The above computer-readable medium may be included in the above electronic device. Alternatively, the computer-readable medium may exist separately, without being assembled into the electronic device.

The above computer-readable medium carries one or more programs. The one or more programs, when executed by the electronic device, cause the electronic device to:
acquire sample data that satisfies preset annotation conditions, where the preset annotation conditions include individual annotation conditions derived from breakdown of an annotation rule corresponding to an annotation task, and the sample data corresponds to chain-of-thought information, which is used to indicate whether the sample data belongs to an annotation category corresponding to the annotation task, as well as a corresponding reason; determine a sample question corresponding to the sample data based on the annotation category and the sample data, and determine a sample answer corresponding to the sample data based on the chain-of-thought information; and perform model training based on the sample question and the sample answer to obtain a target data annotation model, where the target data annotation model is used to obtain, based on an input question including target data, an answer to the question, and the answer includes category information of the target data and target chain-of-thought information corresponding to the category information.

Alternatively, the above computer-readable medium carries one or more programs. The one or more programs, when executed by the electronic device, cause the electronic device to: acquire a question including target data; input the question into a target data annotation model to obtain an answer to the question, the answer including category information of the target data and target chain-of-thought information corresponding to the category information, where the target data annotation model is obtained through model training performed by the above method for training a data annotation model; and annotate the target data based on the category information.

The computer program code for performing the operations of the present disclosure may be compiled using one or more programming languages or a combination thereof, where the programming languages include, but are not limited to, object-oriented programming languages, such as Java, Smalltalk, and C++, and further include conventional procedural programming languages, such as “C” language or similar programming languages. The program code may be executed fully on a client computer, executed partially on a client computer, executed as an independent software package, executed partially on a client computer and partially on a remote computer, or executed fully on a remote computer or a server. In the case of involving the remote computer, the remote computer may be connected to the client computer through any type of network, including a local area network (LAN) or a wide area network (WAN), or may be connected to an external computer (e.g., utilizing an Internet service provider for Internet connectivity).

The flowcharts and the block diagrams in the accompanying drawings illustrate the possible architecture, functions, and operations of the system, the method, and the computer program product according to the various embodiments of the present disclosure. In this regard, each block in the flowcharts or the block diagrams may represent a module, a program segment, or a part of code, and the module, the program segment, or the part of code includes one or more executable instructions for implementing specified logic functions. It should also be noted that, in some alternative implementations, the functions indicated in the blocks may also occur in a different order than indicated in the accompanying drawings. For example, two blocks shown in succession may actually be performed substantially in parallel, or may sometimes be performed in a reverse order, depending on the functions involved. It should also be noted that each block in the block diagrams and/or the flowcharts, and a combination of the blocks in the block diagrams and/or the flowcharts may be implemented by using a dedicated hardware-based system that executes specified functions or operations, or may be implemented by using a combination of dedicated hardware and computer instructions.

The involved modules described in the embodiments of the present disclosure may be implemented through software or hardware. The names of the modules in a certain scenario do not constitute a limitation on the modules themselves.

Herein, the functions described above may be at least partially executed by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), etc.

In the context of the present disclosure, a machine-readable medium may be a tangible medium that may include or store a program used by or used in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include an electrical connection based on one or more wires, a portable computer disk, a hard disk, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination of the above content.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing disclosed concept, such as a technical solution formed by replacing the foregoing features with the technical features with similar functions disclosed (but not limited to) in the present disclosure.

In addition, although the various operations are depicted in a specific order, this should not be construed as requiring that these operations be performed in the specific order shown or in a sequential order. Under certain circumstances, multitasking and parallel processing may be advantageous. Similarly, although a number of specific implementation details are included in the foregoing discussions, these details should not be construed as limiting the scope of the present disclosure. Some features that are described in the context of separate embodiments may also be implemented in combination in one single embodiment. In contrast, various features described in the context of one single embodiment may alternatively be implemented in a plurality of embodiments separately or in any suitable subcombination.

Although the subject matter has been described with reference to specific structural features and/or logic actions of the method, it should be understood that the subject matter defined in the appended claims is not necessarily limited to the specific features or actions described above. In contrast, the specific features and actions described above are merely exemplary implementations of the subject matter defined in the claims. With respect to the apparatuses in the above embodiments, the specific manner in which each module performs its operation has been described in detail in the embodiments related to the method, and will not be detailed herein.

1. A method for training a data annotation model, the method comprising:
acquiring sample data that satisfies preset annotation conditions, wherein the preset annotation conditions comprise individual annotation conditions derived from breakdown of an annotation rule corresponding to an annotation task, and the sample data corresponds to chain-of-thought information, which is used to indicate whether the sample data belongs to an annotation category corresponding to the annotation task, as well as a corresponding reason;
determining a sample question corresponding to the sample data based on the annotation category and the sample data, and determining a sample answer corresponding to the sample data based on the chain-of-thought information; and
performing model training based on the sample question and the sample answer to obtain a target data annotation model, wherein the target data annotation model is used to obtain, based on an input question comprising target data, an answer to the question, and the answer comprises category information of the target data and target chain-of-thought information corresponding to the category information.

2. The method of claim 1, wherein the acquiring sample data that satisfies preset annotation conditions comprises:
acquiring the sample data according to at least one of the following approaches:
acquiring first sample data that satisfies each of the individual annotation conditions and does not satisfy an exemption condition;
acquiring second sample data that satisfies a plurality of the individual annotation conditions simultaneously and does not satisfy the exemption condition; and
acquiring third sample data that satisfies at least one of the individual annotation conditions and satisfies the exemption condition, wherein the exemption condition represents a condition under which the sample data is not to be annotated with the annotation category.

3. The method of claim 2, wherein the exemption condition comprises at least one of the following conditions:
the sample data comprises content representing that the sample data does not belong to the annotation category;
the sample data comprises content of other categories in addition to the annotation category; and
a data source of the sample data satisfies preset conditions.

4. The method of claim 1, wherein the acquiring sample data that satisfies preset annotation conditions comprises:
generating the sample data based on the preset annotation conditions and a data generation model; and/or
searching a sample database for the sample data based on the preset annotation conditions.

5. The method of claim 1, wherein the individual annotation conditions are obtained by:
acquiring a standard operation procedure document corresponding to the annotation task; and
breaking down an annotation rule for the annotation category in the standard operation procedure document to obtain individual annotation conditions corresponding to an associated category of the annotation category; or
breaking down an annotation rule for the annotation category in the standard operation procedure document to obtain individual annotation conditions corresponding to a subcategory of the annotation category, and determining individual annotation conditions corresponding to an associated category of the subcategory.

6. The method of claim 1, wherein the chain-of-thought information corresponding to the sample data is determined through at least one of the following approaches:
acquiring manually configured chain-of-thought information for the sample data;
when the preset annotation conditions comprise a plurality of different types of annotation conditions, determining a target annotation condition that the sample data satisfies from the preset annotation conditions, and determining, based on the target annotation condition and a preset chain-of-thought template, the chain-of-thought information corresponding to the sample data; and
obtaining initial chain-of-thought information corresponding to the sample data through a model for constructing chain-of-thought information, acquiring a manual verification result for the initial chain-of-thought information, and determining, based on the manual verification result and the initial chain-of-thought information, the chain-of-thought information corresponding to the sample data.

7. The method of claim 1, wherein the target data annotation model comprises at least one of: a text-to-text model, a text-to-image model, an image-to-text model, an image-text multimodal model, and a video-text multimodal model.

8. A data annotation method, comprising:
acquiring a question comprising target data;
inputting the question into a target data annotation model to obtain an answer to the question, the answer comprising category information of the target data and target chain-of-thought information corresponding to the category information, wherein the target data annotation model is obtained through model training performed according to the method for training a data annotation model of claim 1; and
annotating the target data based on the category information.

9. An apparatus for training a data annotation model, the apparatus comprising:
a first acquiring module configured to acquire sample data that satisfies preset annotation conditions, wherein the preset annotation conditions comprise individual annotation conditions derived from breakdown of an annotation rule corresponding to an annotation task, and the sample data corresponds to chain-of-thought information, which is used to indicate whether the sample data belongs to an annotation category corresponding to the annotation task, as well as a corresponding reason;
a first determination module configured to determine a sample question corresponding to the sample data based on the annotation category and the sample data, and determine a sample answer corresponding to the sample data based on the chain-of-thought information; and
a training module configured to perform model training based on the sample question and the sample answer to obtain a target data annotation model, wherein the target data annotation model is used to obtain, based on an input question comprising target data, an answer to the question, and the answer comprises category information of the target data and target chain-of-thought information corresponding to the category information.

10. A data annotation apparatus, comprising:
a second acquiring module configured to acquire a question comprising target data;
an input module configured to input the question into a target data annotation model to obtain an answer to the question, the answer comprising category information of the target data and target chain-of-thought information corresponding to the category information, wherein the target data annotation model is obtained through model training performed by the apparatus for training a data annotation model of claim 9; and
an annotation module configured to annotate the target data based on the category information.

11. A computer-readable medium having a computer program stored thereon, wherein the program, when executed by a processing apparatus, causes the steps of the method of claim 1 to be implemented.

12. An electronic device, comprising:
a storage apparatus having a computer program stored thereon; and
a processing apparatus configured to execute the computer program in the storage apparatus to implement the steps of the method of claim 1.

13. The method of claim 2, wherein the individual annotation conditions are obtained by:
acquiring a standard operation procedure document corresponding to the annotation task; and
breaking down an annotation rule for the annotation category in the standard operation procedure document to obtain individual annotation conditions corresponding to an associated category of the annotation category; or
breaking down an annotation rule for the annotation category in the standard operation procedure document to obtain individual annotation conditions corresponding to a subcategory of the annotation category, and determining individual annotation conditions corresponding to an associated category of the subcategory.

14. The method of claim 3, wherein the individual annotation conditions are obtained by:
acquiring a standard operation procedure document corresponding to the annotation task; and
breaking down an annotation rule for the annotation category in the standard operation procedure document to obtain individual annotation conditions corresponding to an associated category of the annotation category; or
breaking down an annotation rule for the annotation category in the standard operation procedure document to obtain individual annotation conditions corresponding to a subcategory of the annotation category, and determining individual annotation conditions corresponding to an associated category of the subcategory.

15. The method of claim 4, wherein the individual annotation conditions are obtained by:
acquiring a standard operation procedure document corresponding to the annotation task; and
breaking down an annotation rule for the annotation category in the standard operation procedure document to obtain individual annotation conditions corresponding to an associated category of the annotation category; or
breaking down an annotation rule for the annotation category in the standard operation procedure document to obtain individual annotation conditions corresponding to a subcategory of the annotation category, and determining individual annotation conditions corresponding to an associated category of the subcategory.

16. The method of claim 2, wherein the chain-of-thought information corresponding to the sample data is determined through at least one of the following approaches:
acquiring manually configured chain-of-thought information for the sample data;
when the preset annotation conditions comprise a plurality of different types of annotation conditions, determining a target annotation condition that the sample data satisfies from the preset annotation conditions, and determining, based on the target annotation condition and a preset chain-of-thought template, the chain-of-thought information corresponding to the sample data; and
obtaining initial chain-of-thought information corresponding to the sample data through a model for constructing chain-of-thought information, acquiring a manual verification result for the initial chain-of-thought information, and determining, based on the manual verification result and the initial chain-of-thought information, the chain-of-thought information corresponding to the sample data.

17. The method of claim 3, wherein the chain-of-thought information corresponding to the sample data is determined through at least one of the following approaches:
acquiring manually configured chain-of-thought information for the sample data;
when the preset annotation conditions comprise a plurality of different types of annotation conditions, determining a target annotation condition that the sample data satisfies from the preset annotation conditions, and determining, based on the target annotation condition and a preset chain-of-thought template, the chain-of-thought information corresponding to the sample data; and
obtaining initial chain-of-thought information corresponding to the sample data through a model for constructing chain-of-thought information, acquiring a manual verification result for the initial chain-of-thought information, and determining, based on the manual verification result and the initial chain-of-thought information, the chain-of-thought information corresponding to the sample data.

18. The method of claim 4, wherein the chain-of-thought information corresponding to the sample data is determined through at least one of the following approaches:
acquiring manually configured chain-of-thought information for the sample data;
when the preset annotation conditions comprise a plurality of different types of annotation conditions, determining a target annotation condition that the sample data satisfies from the preset annotation conditions, and determining, based on the target annotation condition and a preset chain-of-thought template, the chain-of-thought information corresponding to the sample data; and
obtaining initial chain-of-thought information corresponding to the sample data through a model for constructing chain-of-thought information, acquiring a manual verification result for the initial chain-of-thought information, and determining, based on the manual verification result and the initial chain-of-thought information, the chain-of-thought information corresponding to the sample data.

19. The method of claim 2, wherein the target data annotation model comprises at least one of: a text-to-text model, a text-to-image model, an image-to-text model, an image-text multimodal model, and a video-text multimodal model.

20. The method of claim 3, wherein the target data annotation model comprises at least one of: a text-to-text model, a text-to-image model, an image-to-text model, an image-text multimodal model, and a video-text multimodal model.
